(19) United States
(12) Patent Application Publication
(10) Pub. No.: US 2025/0139553 A1
(43) Pub. Date: May 1, 2025

(54) INFORMATION PROCESSING APPARATUS

(71) Applicant: TOYOTA JIDOSHA KABUSHIKI KAISHA, Aichi-ken (JP)

(72) Inventors: Isao SATO, Nagoya-shi (JP); Tomoyoshi UEKI, Toyota-shi (JP); Hiroshi YAMASAKI, Nagoya-shi (JP); Nao MATSUBARA, Toyota-shi (JP)

(21) Appl. No.: 18/926,319

(22) Filed: Oct. 25, 2024

(30) Foreign Application Priority Data
Oct. 27, 2023 (JP) 2023-184938

(51) Int. Cl. G06Q 10/0631; G06Q 10/30

(52) U.S. Cl. CPC G06Q 10/06316; G06Q 10/30

(57) ABSTRACT

An information processing apparatus includes a controller comprising at least one processor. The controller determines, among a plurality of batteries that are subjected to either a recycling process in which the batteries are reused as resources, or a rebuilding process in which the batteries are used in a rebuild in which some or all of the parts are reused, a high priority be given to collection of the batteries that are to be subjected to the rebuilding process. The controller outputs instruction information for instructing the collection of the plurality of batteries in accordance with the determined priority for the collection of the plurality of batteries.

### CROSS REFERENCE TO THE RELATED APPLICATION

This application claims the benefit of Japanese Patent Application No. 2023-184938, filed on Oct. 27, 2023, which is hereby incorporated by reference herein in its entirety.

### BACKGROUND

### Technical Field

The present disclosure relates to an information processing device.

### Description of the Related Art

Japanese Patent Laid-Open No. 2004-192268 discloses a method for planning waste transportation. In the waste transportation planning method disclosed in Japanese Patent Laid-Open No. 2004-192268, a plan is made for collecting waste discharged at each collection point within a certain area and transporting it to a relay processing center for a waste treatment facility. In a waste transport planning method, possible routes for transporting waste within a certain area are maintained. In addition, in the waste transportation planning method, the amount and packaging form of waste to be collected at a plurality of collection points on a transportable route are obtained. Then, in the waste transportation planning method, based on the amount of waste collected at each collection point and the packing form, each collection point is patrolled, waste is collected at each collection point, and the collection route returned to the relay treatment base is determined.

### SUMMARY

The present disclosure aims to enable efficient recovery of batteries.

An information processing apparatus, according to the present disclosure, includes a controller comprising at least one processor configured to;
determine, among a plurality of batteries that are subjected to either a recycling process in which the batteries are reused as resources, or a rebuilding process in which the batteries are used in a rebuild in which some or all of the parts are reused, a high priority be given to collection of the batteries that are to be subjected to the rebuilding process, and
output instruction information for instructing the collection of the plurality of batteries in accordance with the determined priority for the collection of the plurality of batteries.

The present disclosure enables efficient recovery of batteries.

### BRIEF DESCRIPTION OF THE DRAWINGS

FIG. 1 is a diagram showing a schematic configuration of a recovery system;

FIG. 2 is a block diagram showing an example of a functional configuration of a server constituting the collection system;

FIG. 3 is a diagram showing an example of a table configuration of battery information;

FIG. 4 is a flowchart of the process executed by the controller;

FIG. 5 is a diagram showing an example of the change in battery deterioration over time.

### DESCRIPTION OF THE EMBODIMENTS

Assume that batteries are collected for recycling or rebuilding. Here, the recycling process refers to the process of reusing batteries as resources. The rebuilding process is a process for reusing some or all of the battery components for rebuilding. In this case, the longer the storage period, the more the battery deteriorates due to storage degradation and the like. In such a case, the recovered battery may become unusable for rebuilding due to battery deterioration. On the other hand, since batteries used in recycling are reused as resources, it is expected that the impact of deterioration of the batteries will be smaller than that of batteries used for rebuilding. Therefore, the information processing device according to the present disclosure solves such a problem.

A controller, comprising at least one processor, of the information processing apparatus determines that among a plurality of batteries to be subjected to either recycling processing or rebuilding processing, the priority of recovery of the batteries to be subjected to rebuilding process is increased. Then, the controller of the information processing device outputs instruction information for instructing the disposal of the plurality of batteries according to the determined priorities for disposal of the plurality of batteries.

As described above, the information processing device determines that the collection priority of batteries to be rebuilt is higher than that of batteries to be recycled. Therefore, when a plurality of batteries includes both batteries to be recycled and batteries to be rebuilt, the batteries to be rebuilt can be preferentially collected. This makes it possible to speed up the collection of batteries to be rebuilt, and to prevent the batteries from deteriorating and becoming unable to be reused. In this way, batteries can be efficiently recycled.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure to only those.

### Embodiment

### (System Overview)

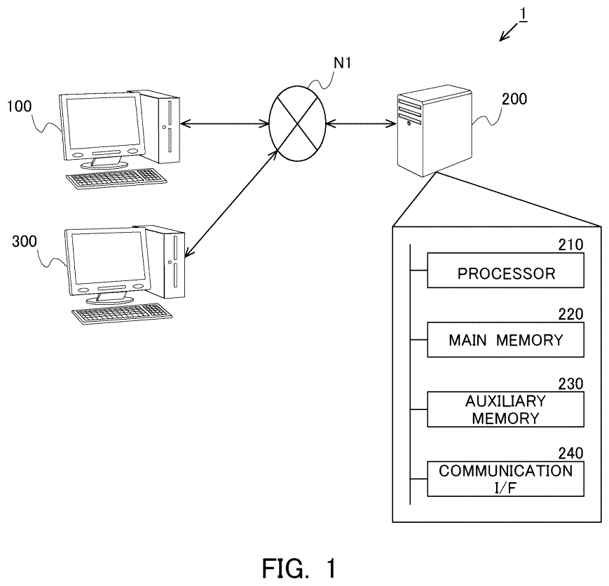

A collection system 1 according to the present embodiment will be described with reference to FIG. 1. FIG. 1 is a diagram showing a schematic configuration of a collection system 1. The collection system 1 includes a dealer terminal 100, a server 200, and a collection company terminal 300. In the collection system 1, a dealer terminal 100, a server 200, and a collection company terminal 300 are interconnected via a network N1. The network N1 may be, for example, a WAN (Wide Area Network), which is a global public communication network such as the Internet, or a telephone communication network such as a mobile phone.

### (Dealer Terminal)

The dealer terminal 100 is a terminal used by a vehicle dealer (hereinafter, may be simply referred to as a “dealer”). The dealer terminal 100 is, for example, a computer or a portable information terminal used by a dealer.

The dealer removes the battery (hereinafter sometimes simply referred to as the “battery”) installed in the vehicle. At this time, the dealer will remove the battery from the vehicle for either a recycling or rebuilding process. The dealer then stores the removed battery. Here, the battery is a battery for driving a motor of a battery-powered electric vehicle, a hybrid electric vehicle, or the like. The battery may also be a battery used as an auxiliary battery in a vehicle.

Recycling is a process for reusing batteries as resources. The recycling process is, for example, a process in which the batteries are crushed and metals contained in the batteries (iron, copper, gold, lithium, nickel, cobalt, etc.) are extracted as resources. This allows the extracted resources such as metals to be used for the manufacture of new products.

Also, the rebuilding process is a process used for the rebuild for reuse of a part or the whole of the parts. The rebuilding process is the process of disassembling the battery into parts and reusing the reusable parts as batteries for other vehicles. Here, the battery components are, for example, cells that constitute the battery. Furthermore, the battery component may be, for example, a module or a substrate that constitutes the battery. In such cases, the parts removed from the battery are reused as parts in newly manufactured batteries. In the rebuilding process, the battery may be used as is by not disassembling it but reassembling it as a battery for another vehicle.

The dealer terminal 100 transmits the battery information to the server 200 via the network N1. Here, the battery information is information about batteries stored by the dealer. The battery information includes information as to whether each battery is a battery that will undergo recycling processing (hereinafter, may be referred to as a “battery for recycling processing”) or a battery that will undergo rebuilding processing (hereinafter, may be referred to as a “battery for rebuilding processing”). The battery information is generated, for example, by a dealer determining whether the battery is to be reused for recycling or rebuilding, and inputting the battery information into the dealer terminal 100. Here, the determination as to whether a battery is a battery for recycling or a battery for rebuilding is made by the dealer by checking the state of the battery. That is, the dealer registers a battery in good condition in the battery information as a battery for the rebuilding process.

### (Server)

The server 200 is a server device that manages the collection of batteries stored by dealers. The server 200 receives the battery information from the dealer terminal 100 via the network N1.

The server 200 also transmits instruction information to the collection company terminal 300 via the network N1. Here, the instruction information is information that instructs the dealer to collect a plurality of batteries stored therein. At this time, the number of batteries held by the dealer may exceed the number of batteries that the collection company can collect. In this case, the server 200 must prioritize the multiple batteries held by the dealer and determine which of the multiple batteries to collect based on the priorities.

Here, it is assumed that the longer the storage period, the more the battery will deteriorate due to storage degradation and the like. In such a case, the collected batteries may become unusable for rebuilding due to deterioration of the batteries. On the other hand, since batteries for recycling are reused as resources, it is expected that the impact of deterioration of the batteries will be smaller than that of batteries used for rebuilding. Therefore, server 200 determines the priority of collection of batteries for the rebuilding process to be higher than the collection rate of batteries for the recycling process. The method in which the server 200 determines the priorities for collecting multiple batteries will be described in detail below.

The server 200 includes a computer having a processor 210, a main memory 220, an auxiliary memory 230, and a communication interface (communication I/F) 240. The processor 210 is, for example, a central processing unit (CPU) or a digital signal processor (DSP). The main memory 220 is, for example, a RAM (Random Access Memory). The auxiliary memory 230 is, for example, a ROM (Read Only Memory). The auxiliary memory 230 is, for example, a HDD (Hard Disk Drive), or a disk recording medium such as a CD-ROM, a DVD disk, or a Blu-ray disk. The auxiliary memory 230 may be a removable medium. Here, examples of removable media include a USB memory and an SD card. The communication I/F 240 is, for example, a local area network (LAN) interface board or a wireless communication circuit for wireless communication.

In the server 200, the auxiliary memory 230 stores an operating system (OS), various programs, various information tables, and the like. In addition, in the server 200, the processor 210 can realize various functions, which will be described later, by loading a program stored in the auxiliary memory 230 into the main memory 220 and executing it. However, some or all of the functions of the server 200 may be realized by a hardware circuit such as an ASIC or an FPGA. It should be noted that the server 200 does not necessarily have to be realized by a single physical configuration, but may be configured by multiple computers working in cooperation with each other. Similarly to the server 200, the dealer terminal 100 includes a computer.

### (Collection Company Terminal)

The collection company terminal 300 is a terminal used by a company that collects batteries (a collector). The collection company terminal 300 is configured to include a computer, similar to the server 200. The collection company terminal 300 receives the instruction information from the server 200 via the network N1. This allows the collection company to know which batteries to collect from among the multiple batteries stored by the dealer. As a result, multiple batteries stored in the dealer are collected by the collector. The battery does not necessarily have to be stored removed from the vehicle. The battery may, for example, remain installed in the vehicle and be removed from the vehicle when the collection company collects the vehicle. The collecting company may also collect the battery together with the vehicle.

In this embodiment, the server 200 transmits instruction information to the collection company terminal 300. However, the server 200 does not necessarily have to transmit the instruction information to the collection company terminal 300. The server 200 may, for example, transmit instruction information directly to a vehicle (collection vehicle) that collects the battery. In this case, the instruction information includes information indicating the location where the batteries are to be collected and information indicating the batteries to be collected. Then, the collection vehicle that has received the instruction information autonomously drives to the location where the dealer is storing the battery in accordance with the instruction information, and displays information indicating the battery to be collected to the dealer. The dealer loads the batteries into a collection vehicle in accordance with the displayed information indicating the batteries to be collected. In this manner, the batteries are collected.

### (Functional Configuration)

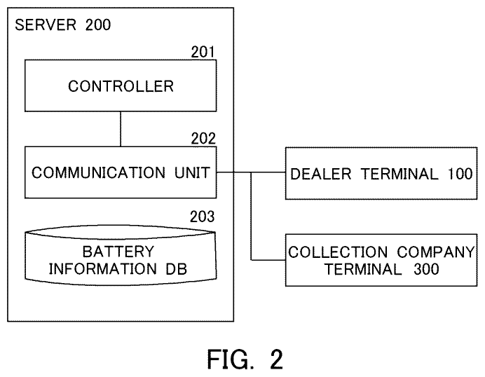

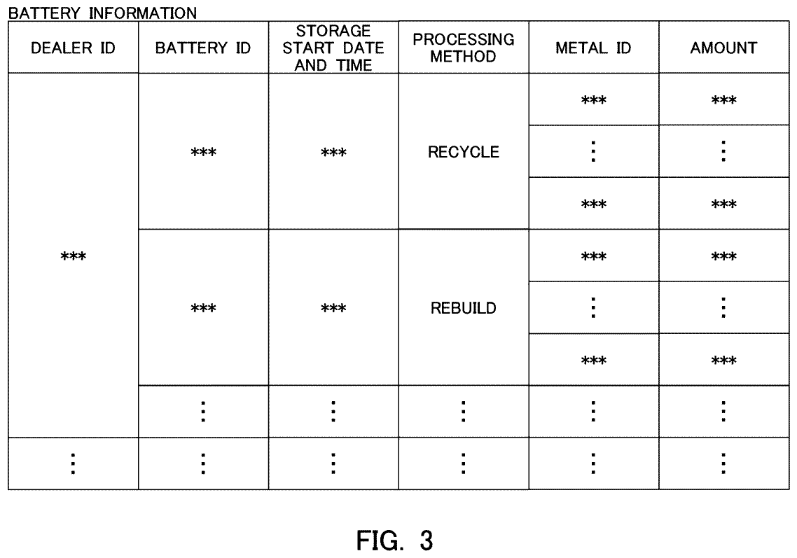

Next, the functional configuration of the server 200 constituting the collection system 1 will be described with reference to FIG. 2 and FIG. 3. FIG. 2 is a block diagram showing an example of a functional configuration of the server 200 constituting the collection system 1. As shown in FIG.

The server 200 includes a controller 201, a communication unit 202, and a battery information database 203 (battery information DB 203). The server 200 can be realized by a processor 210 in the server 200. The communication unit 202 has a function of connecting the server 200 to the network N1. The communication unit 202 can be realized by the communication I/F 240 in the server 200.

The battery information DB 203 has a function of storing battery information. The battery information DB 203 can be realized by the auxiliary memory 230 in the server 200. The controller 201 receives battery information from the dealer terminal 100 via the communication unit 202. The controller 201 stores the received battery information in the battery information DB 203.

FIG. 3 is a diagram showing an example of a table configuration of battery information. The battery information includes a dealer ID deare, a battery ID field, a storage start date and time field, a processing method field, a metal ID field, and a quantity field.

The dealer ID field stores an identifier (dealer ID) for identifying the dealer that transmitted the battery information. When server 200 manages the collection of batteries stored by a plurality of dealers, a plurality of dealer IDs are stored in the battery information. The battery ID field stores an identifier (battery ID) for identifying a battery stored by a dealer having a corresponding dealer ID. The storage start date and time field stores information indicating the date and time when storage of the battery with the corresponding battery ID started (storage start date and time). Here, the storage start date and time is the date and time when the battery was removed from the vehicle. The storage start date and time may also be the date and time when the vehicle was picked up by the dealer, or the date and time when the battery was last discharged or charged.

The processing method field stores information indicating the processing method for the battery with the corresponding battery ID. The processing method field stores information indicating either the recycling process or the rebuilding processing. In the disposal method field, “RECYCLE” is entered if the battery is for recycling. In addition, in the processing method field, if the battery is a battery for rebuilding process, “REBUILD” is entered.

The metal ID field stores an identifier (metal ID) for identifying the type of metal contained in the battery of the corresponding battery ID. The battery information also includes a metal ID corresponding to each metal contained in the battery having the corresponding battery ID. The amount field stores information indicating the amount of the metal of the type corresponding to the metal ID contained in the battery of the corresponding battery ID.

The controller 201 acquires the battery information stored in the battery information DB 203, thereby being able to grasp information about the batteries stored at the dealer. At this time, the amount of batteries stored at the dealer may exceed the amount that the collection company can collect (hereinafter, may be referred to as the “collection amount”). In this case, the controller 201 refers to the battery information and determines the priority of collection of the multiple batteries.

Specifically, the controller 201 acquires the treatment method for each of a plurality of batteries stored at the dealer. Then, the controller 201 determines the priority of collection of batteries for the rebuilding process to be higher than that of batteries for the recycling process. At this time, the dealer may have multiple batteries for the rebuilding process stored. Furthermore, dealers may have a stock of batteries for rebuilding that exceeds the collection amount.

Therefore, the controller 201 determines that, among a plurality of batteries for rebuilding processes, a battery that has been stored for a long period of time is to be given a high priority for collection. Specifically, the controller 201 refers to the storage start date and time stored in the storage start date and time field in the battery information, and calculates the storage period. Then, the controller 201 determines that the recovery priority of a battery for the rebuilding process that has been stored for a long period of time is high, among the multiple batteries for the rebuilding process. This makes it possible to collect batteries for the rebuilding process with priority given to batteries that have been stored for a longer period of time when the number of stored batteries for the rebuilding process exceeds the collection amount.

In this embodiment, the collection company collects batteries stored at one dealer. However, a collection company may collect a plurality of batteries stored at a plurality of dealers in a predetermined area. In this case, when the quantity of the batteries stored at the multiple dealers exceeds the collection amount, the controller 201 determines the priority of collection of the batteries stored at the multiple dealers.

The controller 201 generates instruction information for instructing the dealer to collect a plurality of batteries stored therein, in accordance with the determined priority. Here, the controller 201 generates instruction information for instructing the collection of batteries in descending order of priority. That is, controller 201 generates instruction information to prioritize collection of batteries for the rebuilding process in the order of the longest storage period. Furthermore, when the amount of batteries for rebuilding is less than the collection amount, the controller 201 issues an instruction to also collect batteries for recycling. In this manner, the controller 201 generates instruction information that instructs the dealer to collect the collection amount of batteries collected. Then, the controller 201 transmits the instruction information to the collection company terminal 300 via the communication unit 202.

### (Flowchart)

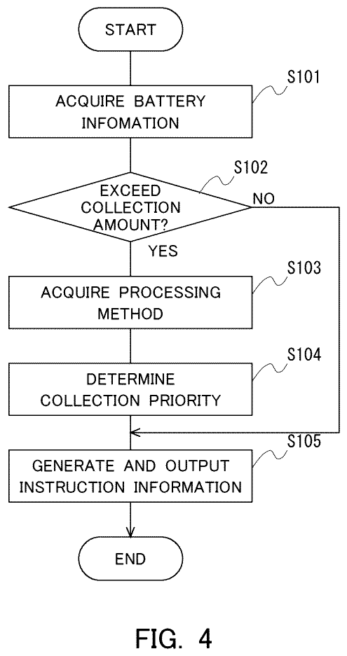

Next, the process executed by the controller 201 in the server 200 in the collection system 1 will be described with reference to FIG. 4. FIG. 4 is a flowchart of the process executed by the controller 201. This process is a process for outputting instruction information. This process is executed at a predetermined timing. The predetermined timing is, for example, the timing when a recycling company collects the battery.

In the process shown in FIG. 4, first, in S101, battery information is acquired from the battery information DB 203. Next, in S102, it is determined whether the amount of batteries stored at the dealer exceeds the collection amount. If a negative determination is made in S102, the amount of batteries stored at the dealer does not exceed the collection amount. Therefore, the collector can collect all of the batteries stored at the dealer. Therefore, in S105, instruction information is generated to instruct the dealer to collect all of the batteries stored at the dealer, and is output to the collection company terminal 300. Then, the process shown in FIG. 4 ends.

If a positive determination is made in S102, the amount of batteries stored at the dealer exceeds the collection amount. Therefore, the collection company cannot collect all of the batteries stored at the dealer. Therefore, it is necessary to determine the priority of collection for a plurality of batteries stored at a dealer. Therefore, in S103, the battery information is referenced and the processing method for each of the multiple batteries stored at the dealer is obtained. Next, in S104, the collection priority is determined according to the treatment method for each of the plurality of batteries stored at the dealer. Next, in S105, instruction information according to the priority of collection is generated and output to the collection company terminal 300 of the collection company. That is, in S105, instruction information for collecting batteries of the collection amount in order of priority is generated and output. Then, the process shown in FIG. 4 ends.

As described above, in the collection system 1, batteries for the rebuilding process are determined to have a higher collection priority than batteries for the recycling process. Therefore, in a case where a dealer stores both batteries for recycling and batteries for rebuilding, the batteries for rebuilding can be collected preferentially. This allows for the batteries to be collected for the rebuilding process at an earlier time, and prevents the batteries from deteriorating to the point where they cannot be reused. Furthermore, in this embodiment, when a plurality of batteries for rebuilding are stored at a dealer, the battery that has been stored for the longest period of time is given a higher priority. This makes it possible to prioritize collection of batteries for rebuilding processes that have been stored for a long period of time. This makes it possible to prevent the batteries for rebuilding from deteriorating due to a long storage period, making them unable to be reused. In this way, batteries can be efficiently recycled.

### Variation 1

In the present embodiment, the server 200 determines the priority of the battery having a long storage period among the plurality of batteries for the rebuilding process. However, among batteries for use in the rebuilding process, batteries that have been stored for a certain period of time or longer are expected to become unsuitable for use in the rebuilding process due to the progression of storage deterioration and other factors. Therefore, server 200 may determine the priority of batteries for the rebuilding process that have been stored for a predetermined period or longer to be lower than the priority of batteries for the rebuilding process that have been stored for a period shorter than the predetermined period. Here, the predetermined period is a period during which the effects of storage deterioration and the like are expected to become significant and the battery becomes unsuitable for use in a rebuilding process.

At this time, server 200 determines the priority of batteries for the rebuilding process that have been stored for a predetermined time or longer to be the same as that of batteries for the recycling process. Server 200 may also determine the priority of batteries for the rebuilding process that have been stored for a predetermined period or longer to be lower than the priority of batteries for the rebuilding process that have been stored for a period shorter than the predetermined period, but higher than the priority of batteries for the recycling process. At this time, the priority of the batteries for the rebuilding process that have been stored for a predetermined period of time or more may be determined uniformly. Furthermore, even among batteries for rebuilding that have been stored for a predetermined period of time or longer, batteries stored for a shorter period are expected to be less affected by deterioration than batteries stored for a longer period of time. Therefore, the priority of the battery for the rebuilding process stored for a predetermined period or more may be determined higher in order of the shortest storage period.

In this manner, the priority of a battery for the rebuilding process that has been stored for a predetermined period or longer is determined to be lower than the priority of a battery for the rebuilding process that has been stored for less than the predetermined period. Thereby, it is possible to preferentially collect batteries for rebuilding process having a storage period of less than a predetermined period, which is assumed to have a small effect of storage deterioration and the like. This makes it possible to prioritize the collection of batteries suitable for the rebuilding process, while suppressing the collection of batteries unsuitable for the rebuilding process. In this way, the batteries can be efficiently collected.

### Variation 2

It is also expected that the shorter the storage period, the less the impact of storage deterioration on the battery. Therefore, server 200 may determine that a battery with a short storage period is given a high priority among a plurality of batteries for the rebuilding process. This allows for the collection of rebuilding batteries with shorter storage periods to be prioritized, thereby allowing the collection of rebuilding batteries that are more suitable for the rebuilding process to be prioritized over batteries for the rebuilding process that have been stored for longer periods.

### Variation 3

A collection company may collect multiple batteries for recycling. In this case, the server 200 may determine priorities for multiple batteries for recycling processing. Specifically, the server 200 determines the collection priority of each recycle battery according to the type and amount of metal contained in the recycle battery.

Specifically, the server 200 acquires the metal ID field and the quantity field for each battery for recycling process in the battery information held in the battery information DB 203. Then, the server 200 determines the priority order in descending order of the amount of a predetermined type of metal. This allows efficient collection of batteries for recycling that contain a predetermined type of metal.

Here, the predetermined type of metal is, for example, a precious metal, a base metal, or a rare metal. The predetermined types of metals are set in advance by an administrator of the server 200 or the like. The predetermined type of metal may be determined according to the demand for it as a recyclable resource. In this case, the server 200 acquires, for example, the demand amount of recyclable resources from a server or the like that manages the demand amount. Then, the server 200 determines a predetermined type of metal depending on the acquired demand amount.

Furthermore, the server 200 may determine the priority by referring to a plurality of types of metals and their amounts. In this case, for example, the server 200 calculates the product of the point set for each of the plurality of types of metals and the amount, and determines the priority higher in order of the largest calculated value. Here, the points set for the metals are set in advance by, for example, an administrator of the server 200. Furthermore, the points set for metals may be set to be higher as the demand for metals as recyclable resources increases. In this way, the batteries can be efficiently collected.

### Variation 4

The battery in this embodiment is a battery installed in a vehicle. However, the batteries to be collected do not necessarily have to be batteries installed in vehicles. For example, the battery may be any battery, such as a battery installed in an electrical appliance or a stationary storage battery, that is to be recycled or rebuilt.

### Variation 5

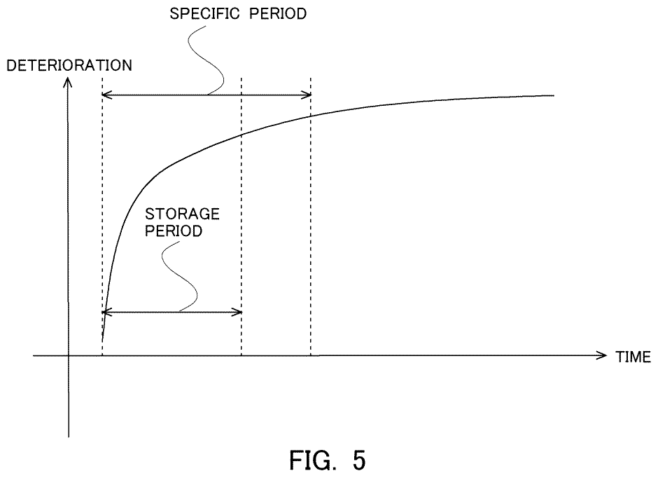

In this modification, it is assumed that the rate of change in the deterioration of the battery changes with time. FIG. 5 is a diagram showing an example of how battery deterioration changes over time. In the example shown in FIG. 5, the rate of change in the degree of battery deterioration (the rate of change in battery deterioration) decreases with the passage of time from the storage start date and time.

When the rate of change in battery deterioration changes in this manner, the rate of change in the battery deterioration level close to the storage start date and time is greater than the rate of change in the battery deterioration level far from the storage start date and time. Therefore, the deterioration progresses more rapidly near the storage start date and time than farther from the storage start date and time.

Therefore, for batteries for rebuilding processes whose storage period falls within a period of a predetermined time after the storage start date and time (hereinafter sometimes referred to as a “specific period”), server 200 determines the priority of collection of batteries for rebuilding processes with shorter storage periods to be higher than the priority of collection of batteries for rebuilding processes with longer storage periods. At this time, for batteries for rebuilding processes whose storage period includes the specific period, the server 200 determines the priority of collection of batteries for rebuilding processes whose storage period is longer to be higher than the priority of collection of batteries for rebuilding processes whose storage period is shorter.

Here, the batteries for the rebuilding process whose storage period is included in the specific period have a greater progression of deterioration than the batteries for the rebuilding process whose storage period includes the specific period. Therefore, collection of batteries for the rebuilding process whose storage period falls within the specific period must be given priority over collection of batteries for the rebuilding process whose storage period includes the specific period. Therefore, the priority of collection of batteries for the rebuilding process whose storage period falls within the specific period is determined to be higher than the priority of collection of batteries for the rebuilding process whose storage period includes the specific period. The specific period is determined by the date and time when the rate of change in battery deterioration becomes equal to or less than a predetermined value. The predetermined value is determined in advance as a value that is judged to be less affected by the progression of deterioration.

In this way, the server 200 changes the method of determining the collection priority depending on whether the storage period is included in the specific period or the specific period is included in the storage period. As a result, for batteries for the rebuilding process whose storage period falls within the specific period, batteries with shorter storage periods are given priority in collection. This allows priority to be given to the collection of batteries for the rebuilding process when the deterioration is most advanced. Therefore, batteries for rebuilding that are less deteriorated can be collected preferentially.

Furthermore, for batteries for rebuilding processes whose storage period includes the specific period, the priority for collection is determined as described above. Here, for batteries for the rebuilding process whose storage period includes the specific period, the effect of progression of deterioration is small even with the passage of time. However, although the impact of the progression of deterioration is small, it is expected that if the battery is stored for a certain period of time or longer, it will become unsuitable as a battery for the rebuilding process due to deterioration. In addition, it is possible that a battery stored for a long period of time may become unsuitable for use in a rebuilding process due to factors other than deterioration. Factors other than deterioration include, for example, corrosion due to storage conditions such as high temperature or high humidity, or damage due to external factors. Therefore, by determining the priority of collection as described above, it is possible to prevent batteries for the rebuilding process from becoming unsuitable as batteries for the rebuilding process due to long-term storage.

As described above, the server 200 changes the method of determining the priority depending on whether the storage period is included in the specific period. This makes it possible to suppress the effects of the progression of deterioration while also preventing the battery from becoming unsuitable for use in a rebuilding process due to deterioration. In this way, batteries can be efficiently recycled.

### OTHER EMBODIMENTS

The above-described embodiment is merely an example, and the present disclosure can be modified as appropriate without departing from the spirit and scope of the present disclosure. Furthermore, the processes and means described in this disclosure can be freely combined and implemented as long as no technical contradiction occurs.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. A non-transitory computer-readable storage medium includes any type of medium suitable for storing electronic instructions, such as, for example, any type of disk, such as a magnetic disk (such as a floppy disk or a hard disk drive (HDD)), an optical disk (such as a CD-ROM, a DVD disk, or a Blu-ray disk), a read-only memory (ROM), a random-access memory (RAM), an EPROM, an EEPROM, a magnetic card, a flash memory, or an optical card.

What is claimed is:

1. An information processing apparatus including a controller comprising at least one processor configured to;
determine, among a plurality of batteries that are subjected to either a recycling process in which the batteries are reused as resources, or a rebuilding process in which the batteries are used in a rebuild in which some or all of the parts are reused, a high priority be given to collection of the batteries that are to be subjected to the rebuilding process, and
output instruction information for instructing the collection of the plurality of batteries in accordance with the determined priority for the collection of the plurality of batteries.

2. The information processing apparatus according to claim 1, wherein
determining the priority includes determining that a battery that has been stored for a long period of time is given a high priority among the one or more batteries to be subjected to the rebuilding process.

3. The information processing apparatus according to claim 1, wherein
determining the priority includes determining the priority of a battery that has been stored for a predetermined period or longer, among the one or more batteries to be subjected to the rebuilding process, to be lower than the priority of a battery that has been stored for a period shorter than the predetermined period.

4. The information processing apparatus according to claim 1, wherein
determining the priority includes determining that a battery that has been stored for a short period of time is given a high priority among the one or more batteries to be subjected to the rebuilding process.

5. The information processing apparatus according to claim 1, wherein
determining the priority includes determining the priority according to a type of metal and an amount of the metal contained in the battery to be subjected to the recycling process.
